(19) United States
(12) Patent Application Publication
(10) Pub. No.: US 2026/0217254 A1
(43) Pub. Date: Jul. 30, 2026

(54) A METHOD FOR PROVIDING A PLURALITY OF DRIVING MODES FOR AT LEAST ONE MOTOR VEHICLE, A CORRESPONDING COMPUTER PROGRAM PRODUCT, A CORRESPONDING NON-TRANSITORY COMPUTER-READABLE STORAGE MEDIUM, AS WELL AS A CORRESPONDING CENTRAL ELECTRONIC COMPUTING DEVICE

(71) Applicant: MERCEDES-BENZ GROUP AG, Stuttgart (DE)

(72) Inventors: Thomas MONNINGER, Sunnyvale, CA (US); Aaron BROWN, Santa Clara, CA (US); Vikram BHARADWAJ, Boston, MA (US)

(21) Appl. No.: 19/149,207

(22) PCT Filed: Dec. 29, 2023
(86) PCT No.: PCT/EP2023/088022

§ 371 Date: Jul. 18, 2025

(30) Foreign Application Priority Data
Jan. 20, 2023 (GB) 2300878.2

(51) Int. Cl. B60W 30/182; B60W 30/18; B60W 50/00; B60W 50/14

(52) U.S. Cl. CPC B60W 30/182; B60W 30/18163; B60W 50/14; B60W 2050/0083; B60W 2050/146; B60W 2520/105; B60W 2552/30; B60W 2554/802

(57) ABSTRACT

A central electronic computing device provides a plurality of driving modes for at least one motor vehicle. A plurality of driving behaviors of a plurality of motor vehicles are received by the electronic computing device, which extracts similarities and clusters the plurality of driving behaviors depending on the similarities. A distinct plurality of driving modes is generated depending on the clustering and the plurality of driving modes are provided to the at least one motor vehicle.

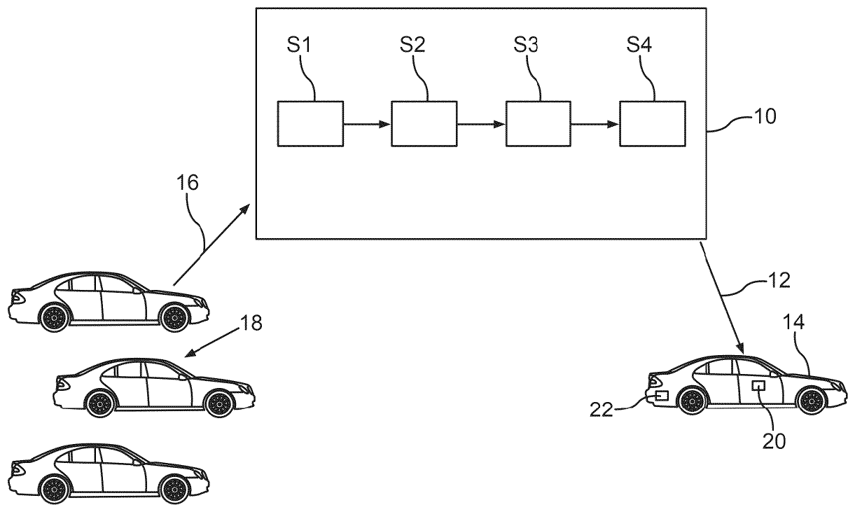

### FIELD OF THE INVENTION

Exemplary embodiments of the present invention relate to the field of automobiles, and more specifically to a method for providing a plurality of driving modes for at least one motor vehicle by a central electronic computing device, as well as to a computer program product, a corresponding non-transitory computer-readable storage medium, as well as to a central electronic computing device.

### BACKGROUND INFORMATION

Driving styles are very individual and subjective. The same ADAS (advanced driver assistance system) may be great for one person, but might feel too cautious or passive for another person. It is therefore desirable to have a preconfigured set of distinct driving styles that matches and is suitable for a large portion of the customer base. Furthermore, it is desirable to identify the relevant parameters that are crucial factors of different driving styles.

### SUMMARY OF THE INVENTION

Exemplary embodiments of the present invention provide a method, a computer program product, a non-transitory computer-readable storage medium, as well as a central electronic computing device, by which a plurality of driving modes is provided for a user of a motor vehicle.

One aspect of the present invention relates to a method for providing a plurality of driving modes for at least one motor vehicle by a central electronic computing device. A plurality of driving behaviors of a plurality of motor vehicles is received by the electronic computing device. Similarities in the plurality of driving behaviors are extracted by the electronic computing device. The plurality of driving behaviors is clustered depending on the similarities by the electronic computing device. A distinct plurality of driving modes is generated depending on the clustering by the electronic computing device and the plurality of driving modes is provided for the at least one motor vehicle.

Therefore, the invention is configured to find relevant parameters that characterize driving styles based on fleet behavior. Also, detected driving styles of a customer fleet are aggregated in a cluster to generate a set of distinct parameter configurations that reflect different driving styles best.

Therefore, the invention describes a system that identifies parameters, which are relevant factors of different driving styles based on monitoring driving behavior of human drivers. Those could be manually defined parameters that affect a driving style, such as maximum acceleration, duration taken for a lane change, distance to a leading vehicle or speed in relation to the lane curvature. Furthermore, this data-driven approach could build latent features that are informative about a driving style, but might not have direct semantic meaning.

According to an embodiment the plurality of distinct driving modes is presented for a selection on a display device of the motor vehicle.

In another embodiment the distinct driving modes are presented before a start of a movement of the motor vehicle.

In another embodiment the plurality of driving behaviors is clustered by parameters for maximum acceleration, a duration taken for a lane change, a distance to a leading vehicle or a speed in relation to the lane curvature.

In another embodiment depending on the selected, distinct driving mode at least one setting of a dynamic driving device of the motor vehicle is adapted.

In another embodiment for extracting the similarities a data-driven approach is used.

In particular, the method is a computer-implemented method. Therefore, another aspect of the present invention relates to a computer program product comprising program code means for performing a method according to the preceding aspect. In particular, the computer program product may also be regarded as a computer program.

A still further aspect of the present invention relates to a non-transitory computer-readable storage medium comprising at least the computer program product according to the preceding aspect.

A still further aspect of the present invention relates to a central electronic computing device for providing a plurality of driving modes for at least one motor vehicle, wherein the central electronic computing device is configured for performing a method according to the preceding aspect. In particular, the method is performed by the central electronic computing device.

The central electronic computing device may comprise processors, circuits, in particular integrated circuits, and further electronic means for performing a method according to the preceding aspect.

Further advantages, features, and details of the invention derive from the following description of a preferred embodiment as well as from the drawing. The features and feature combinations previously mentioned in the description as well as the features and feature combinations mentioned in the following description of the FIGURE and/or shown in the FIGURE alone can be employed not only in the respectively indicated combination but also in any other combination or taken alone without leaving the scope of the invention.

### BRIEF DESCRIPTION OF THE DRAWING

The novel features and characteristic of the disclosure are set forth in the appended claims. The accompanying drawing, which is incorporated in and constitutes a part of this disclosure, illustrates exemplary embodiments and together with the description, serves to explain the disclosed principles. The same numbers are used throughout the FIGURES to reference like features and components. Some embodiments of system and/or methods in accordance with embodiments of the present subject matter are now described below, by way of example only, and with reference to the accompanying FIGURES.

The drawing shows in:

The sole FIGURE, a schematic block diagram according to an embodiment of the central electronic computing device according to the invention.

In the FIGURE the same elements or elements having the same function are indicated by the same reference signs.

### DETAILED DESCRIPTION

In the present document, the word “exemplary” is used herein to mean “serving as an example, instance, or illustration”. Any embodiment or implementation of the present subject matter described herein as “exemplary” is not necessarily to be construed as preferred or advantageous over other embodiments.

While the disclosure is susceptible to various modifications and alternative forms, specific embodiments thereof have been shown by way of example in the drawing and will be described in detail below. It should be understood, however, that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion so that a setup, device or method that comprises a list of components or steps does not include only those components or steps but may include other components or steps not expressly listed or inherent to such setup or device or method. In other words, one or more elements in a system or apparatus preceded by “comprises” or “comprise” does not or do not, without more constraints, preclude the existence of other elements or additional elements in the system or method.

In the following detailed description of the embodiment of the disclosure, reference is made to the accompanying drawing that forms part hereof, and in which is shown by way of illustration a specific embodiment in which the disclosure may be practiced. This embodiment is described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

The sole FIGURE shows a schematic block diagram according to an embodiment of the invention. In particular the sole FIGURE shows a block diagram according to an embodiment of a central electronic computing device 10. The central electronic computing device 10 may comprise processors, circuits, for example integrated circuits, and further electronic means for performing a method according to the present invention. In particular, the central electronic computing device may be configured as a backend server.

According to an embodiment of the present invention a method is presented for providing a plurality of driving modes 12 for at least one motor vehicle 14 by the central electronic computing device 10. In a first step S1 a plurality of driving behaviors 16 of a plurality of motor vehicles 18 is received by the electronic computing device 10. Similarities in the plurality of driving behaviors 16 are extracted by the electronic computing device in a second step S2. In a third step S3 the plurality of driving behaviors 16 are clustered depending on the similarities by the electronic computing device 10. In a fourth step S4 a distinct plurality of driving modes 12 are generated depending on the clustering by the electronic computing device 10 and the plurality of driving modes 12 are provided for the at least one motor vehicle 14. In particular, the plurality of distinct driving modes 12 are presented for selection on a display device 20 of the motor vehicle 14. The distinct driving modes 12 may be presented before a start of a movement of the motor vehicle 14.

Furthermore, depending on the selected, distinct driving mode 12 at least one setting of a dynamic driving device 22 of the motor vehicle 14 is adapted. For example a braking device or a steering device or acceleration device as the dynamic driving device 22 may be adapted.

In particular, the sole FIGURE describes a system that identifies parameters, which are relevant factors of different driving styles based on monitoring the driving behaviors 16 of human drivers. Those could be manually defined parameters that affect a driving style, such as maximum acceleration, duration taken for a lane change, distance to a leading vehicle or speed in relation to a lane curvature. Furthermore, this data-driven approach could build latent features that are informative about driving style, but might not have a direct semantic meaning.

The driving behavior 16 from the plurality of motor vehicles 18 is aggregated in the backend and clustering techniques are used to identify such parameters that are relevant factors of different driving styles. Furthermore, data-driven approaches allow to cluster the different behaviors from the fleet into a small set of distinct styles. Clustering driving behavior across the whole customer fleet allows to derive overall driving patterns as a cross-section of the customer base and provide these as choice for a new driver, as pre-configuration for the drive modes of the motor vehicle 14 or as an explicit choice when starting to drive or move the vehicle.

Finally, the dynamic driving device, which may be for example an ADAS system, has an adaptive driving style that changes the identified parameters according to the selected preset.

Therefore, a preconditioning of the ADAS system is provided, which supports different driving styles to meet a respective subjective customer feeling. Therefore, monitoring the driving behaviors 16 of human drivers in a customer fleet is provided. Parameters that are relevant factors for different driving styles are extracted, and their influence with a data-driven approach is quantified. Clustering the driving behavior 16 across the whole customer fleet to derive overall driving patterns as a cross-section of the customer base is provided. Based on the clustering results, defining a small set of distinct driving styles with corresponding parameter configurations is provided. A driver of the motor vehicle 14 is given an explicit choice when starting to drive or at the beginning of a movement of a vehicle or a map to drive mode selection or a proposal for new driver profiles. The adaptive ADAS system may be configured with a chosen set of parameters that was one derived driving style found in the fleet behavior.

### REFERENCE SIGNS

10 central electronic computing device
12 driving modes
14 motor vehicle
16 plurality of driving behaviors
18 plurality of motor vehicles
20 display device
22 dynamic driving device
S1-S4 steps of the method

1-9. (canceled)

10. A method for providing a plurality of driving modes for at least one motor vehicle by a central electronic computing device, the method comprising:
receiving, by the central electronic computing device, a plurality of driving behaviors of a plurality of motor vehicles;
extracting, by the central electronic computing device, similarities in the plurality of driving behaviors;
clustering, by the central electronic computing device, the plurality of driving behaviors depending on the extracted similarities;
generating, by the central electronic computing device, a distinct plurality of driving modes depending on the clustering; and
providing, by the central electronic computing device, the plurality of driving modes to the at least one motor vehicle.

11. The method of claim 10, further comprising:
presenting, on a display device of the at least one motor vehicle, the plurality of distinct driving modes for selection.

12. The method of claim 11, wherein the plurality of distinct driving modes are presented before a start of a movement of the at least one motor vehicle.

13. The method of claim 10, wherein the plurality of driving behaviors is clustered by parameters for a maximum acceleration, a duration taken for a lane change, a distance to a leading vehicle, or a speed in relation to a lane curvature.

14. The method of claim 10, further comprising:
receiving, by the at least one motor vehicle, a selection of one of the plurality of driving modes; and
adapting, by the at least one motor vehicle based on the received selection, at least one setting of a dynamic driving device of the motor vehicle.

15. The method of claim 10, wherein the extracting of the similarities involves a data driven approach.

16. A non-transitory computer-readable storage medium comprising program code, which when executed by a processor of a central electronic computing device, causing the central electronic computing device to:
receive a plurality of driving behaviors of a plurality of motor vehicles;
extract similarities in the plurality of driving behaviors;
cluster the plurality of driving behaviors depending on the extracted similarities;
generate a distinct plurality of driving modes depending on the clustering; and
provide the plurality of driving modes to at least one motor vehicle.
